(19) United States
(12) Patent Application Publication
(10) Pub. No.: US 2008/0298583 A1
(43) Pub. Date: Dec. 4, 2008

(54) System and method of quantum encryption

(75) Inventor: Nabeel Ahmed, Bangalore (IN)

Correspondence Address: HARNESS, DICKEY & PIERCE, P.L.C., P.O. BOX 8910, RESTON, VA, 20195, US

(73) Assignee: Lucent Technologies Inc.

(21) Appl. No.: 11/806,333

(22) Filed: May 31, 2007

(51) Int. Cl. H04L 9/22

(52) U.S. Cl. 380/46; 380/44

(57) ABSTRACT

The present invention relates to a crypto-system. According to one embodiment, the crypto-system includes a key synchronizer and/or cryptographic circuitry. The key synchronizer is configured to synchronize a cryptographic key stream with another communication entity using polarized photons. The cryptographic circuitry is configured to generate cipher text from plain text and/or plain text from cipher text, based on the synchronized key stream.

### BACKGROUND

Quantum cryptography uses the principles of quantum mechanics to provide secure communications among communicating entities. Conventional methods of cryptography use computationally complex mathematical techniques to encrypt information and guard against potential eavesdropping. Unlike conventional methods of cryptography, quantum cryptography depends on the Heisenberg uncertainty principle to protect against potential eavesdropping.

The Heisenberg uncertainty principle states that pairs of canonical conjugate properties cannot be accurately measured simultaneously. In fact, the measurement of one property randomizes the measurement of a conjugate property. In quantum cryptography, quantum packets (for example, photons) may be polarized using a specific polarization basis where an attempt to measure polarization information using an orthogonal polarization basis will destroy the original polarization information. Thus, naïve observers (i.e., eavesdroppers) may inadvertently destroy quantum packets they attempt to measure.

### SUMMARY

The present invention relates to a crypto-system. According to one embodiment, the crypto-system includes a key synchronizer and/or cryptographic circuitry. The key synchronizer is configured to synchronize a cryptographic key stream with another communication entity using polarized photons. The cryptographic circuitry is configured to generate cipher text from plain text and/or plain text from cipher text, based on the synchronized key stream.

The present invention also relates to a random bit key stream generator. According to one embodiment, the random bit key stream generator includes a plurality of circular doubly linked lists forming a cryptographic key grid, a key grid mover, and/or a key stream reader. The key grid mover is configured to permute the plurality of circular doubly linked lists. The key stream reader is configured to extract a key stream from the cryptographic key grid.

The present invention also relates to a method of cryptographic data transfer. According to one embodiment, the method includes synchronizing a generated cryptographic key stream seed with another communication entity to produce a synchronized cryptographic key stream seed by exchanging polarized photons. The method also includes generating a synchronized cryptographic key stream using the synchronized cryptographic key stream seed. The method also includes encrypting information and/or decrypting information using the synchronized cryptographic key stream.

The present invention also relates to a method of generating a random bit key stream. According to one embodiment, the method includes initializing a plurality of circular doubly linked lists forming a cryptographic key grid using a seed, permuting the cryptographic key grid, and/or extracting a cryptographic key stream from the cryptographic key grid.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention.

FIG. 1 illustrates a block diagram of a crypto-system according to an example embodiment of the present invention.

FIG. 2 illustrates the seed generators of FIG. 1 in more detail.

FIG. 3 is a client/server flow diagram illustrating the operation of the exchangers of FIG. 1.

FIG. 4 illustrates the key stream generators of FIG. 1 receiving the synchronized cryptographic key stream seed from the synchronizer and outputting the synchronized cryptographic key stream to the encryption/decryption unit, in more detail.

FIG. 5 illustrates an example layout of the cryptographic key grid of FIG. 4.

FIG. 6 illustrates example components of the key grid mover of FIG. 4.

FIG. 7 is a 3-D block abstraction illustrating the operation of the key stream reader of FIG. 4.

FIGS. 8(a) and 8(b) respectively illustrate example encryption and decryption of data by the server and the client of FIG. 1.

FIG. 9 is a client/server flow diagram illustrating a method of cryptographic data transfer between a server and a client according to an example embodiment of the present invention.

### DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

The terms ‘client’ and ‘server’ as used herein are meant to distinguish between an entity generally requesting information (‘client’) and an entity generally providing information (‘server’) at a given time. However, it will be recognized by one of ordinary skill in the art that the entities themselves may serve as both ‘clients’ and ‘servers’ over a given period of time, and thus an entity herein described as a ‘client’ may in fact perform operations attributed to a ‘server’, and vice versa, at a different time. Therefore, the terms ‘client’ and ‘server’ should not be construed as to impart undue limitations unto the entities described herein.

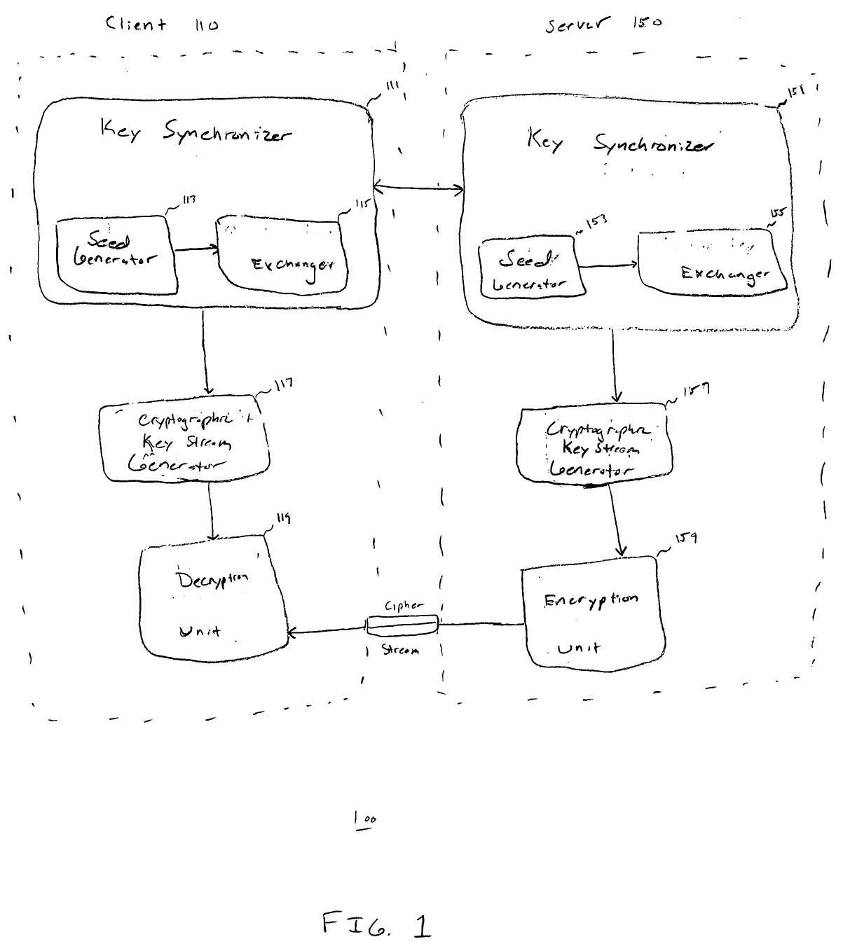

FIG. 1 illustrates a block diagram of a crypto-system according to an example embodiment of the present invention. The crypto-system 100 provides a secure transfer of information between a client 110 and a server 150. The client 110 includes a client key synchronizer 111 connected to a client cryptographic key stream generator 117, which is also connected to a client decryption unit 119. The client key synchronizer 111 includes a client seed generator 113 connected to a client exchanger 115.

Similarly, the server 150 includes a server key synchronizer 151 connected to a server cryptographic key stream generator 157, which is also connected to a server encryption unit 159. The server key synchronizer 151 includes a server seed generator 153 connected to a server exchanger 155. As shown, the server key synchronizer 151 is configured to exchange information with the client key synchronizer 111, and the server encryption unit 159 is configured to exchange information in the form of a cipher stream with the client decryption unit 119.

Secure transfer of encrypted data between the client 110 and server 150 is based on a shared secret synchronized between the two. The key synchronizers 111/151 use the seed generators 113/153 and the exchangers 115/155 to initialize the cryptographic key stream generators 117/157 to a synchronized state (shared secret), which is then propagated through a series of coincident operations.

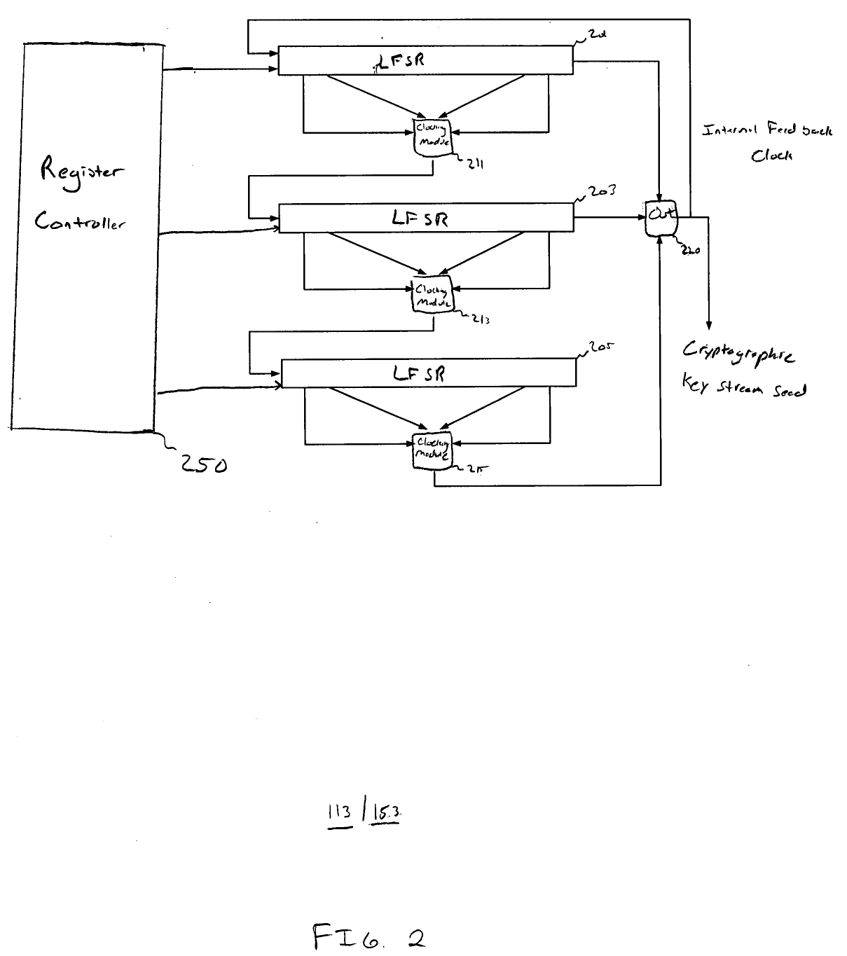

FIG. 2 is a schematic diagram illustrating the seed generators 113/153 of FIG. 1 in more detail, according to an example embodiment of the present invention. As shown, the seed generators 113/153 include first, second, and third linear feedback shift registers (LFSR) 201-205 connected to corresponding clocking modules 211-215, a register controller 250 connected to each LFSR 201-205, and an output module 220. The output module 220 uses outputs of the LFSRs 201-205 and/or clocking modules 211-215 to generate a cryptographic key stream seed. An LFSR is a shift register whose input bit is a linear function of its previous state.

Referring to FIG. 2, one or several bits of LFSR 201 are fed into clocking module 211, and the output of clocking module 211 is connected to LFSR 203. Similarly, one or several bits of LFSR 203 are fed into clocking module 213, and the output of clocking module 213 is connected to LFSR 205. One or several bits of LFSR 205 are fed into clocking module 215. The output of clocking module 215, the output of LFSR 201, and the output of LFSR 203 are fed into output module 220. The output of output module 220 is the cryptographic key stream seed, which may also be connected to LFSR 201.

Although three LFSRs 201-205 and corresponding clocking modules 211-215 are shown in FIG. 2, the total number of registers and clocking modules may be scaled to any number without deviating from the intended scope of the present invention.

The length of each LFSR 201-205 is set dynamically by the register controller 250 according to a desired key length. Each of the three LFSRs 201-205 is set to a primitive length (i.e., a prime number) such that the total number of bits in the registers is equal to the total number of bits of a cryptographic key stream seed with the desired length, unless the desired length necessitates one or several of the registers be set to the next largest prime. For example, with reference to FIG. 2, if the desired cryptographic key stream seed length is 128 bits, the register controller 250 sets LFSR 201 to 43 bits, LFSR 203 to 43 bits, and LFSR 205 to the next largest prime length greater than the remaining 42 bits (i.e., 43 bits).

The LFSRs 201-205 are initialized by the register controller 250 using a given prime number (primary key) known to both the client 110 and server 150 a priori, and thus each LFSR 201-205 contains essentially random values. Following the previous example, once the length of each LFSR 201-205 is set, the register controller 250 puts the first 43 bits of the primary key into LFSR 201, the next 43 bits into LFSR 203, and the remaining bits into LFSR 205. If extra bits are needed to initialize the LFSRs 201-205, the register controller 250 may use a constant value (i.e., a ‘1’ or a ‘0’). The primary key may be any acceptable value agreed upon a priori by the client 110 and server 150.

As shown in FIG. 2, certain bits (taps) of each LFSR 201-205 are fed into corresponding clocking modules 211-215. The taps are determined according to a given primitive polynomial generated by the register controller 250 (described below). Each primitive polynomial includes one or more non-zero terms corresponding to different positive powers of a given variable, and the powers of the non-zero terms determine which bits of a register correspond to the taps. The position of the taps, as determined by the given primitive polynomial, is referred to as a tap sequence.

For example, with reference to FIG. 2, assume the register controller 250 sets LFSR 201 to 11 bits and initializes those 11 bits to ‘01001101001’ using the primary key. Given the example primitive polynomial x¹⁰+x³+1, the register controller 250 sets the 10th, 3rd, and 0th bits of LFSR 201 as the taps. Thus, the values of the 10th, 3rd, and 0th bits of LFSR 201 (‘1’,‘0’, and ‘0’, respectively, in this example) are fed into clocking module 211.

The register controller 250 may generate primitive polynomials using standard algorithms which are well known in the art, or by referencing a lookup table of primitive polynomials for different degrees/orders. While the primitive polynomial used for each register may be of a degree less than the length of its corresponding register, this may decrease the period, and hence robustness, of the generated cryptographic key stream seed.

Each register may use a different primitive polynomial (and tap sequence), although it may be desirable for a given primitive polynomial to be used by multiple registers, for example, to reduce the number of computations required. Furthermore, new primitive polynomials may be used at each invocation of the seed generators 113/153. The use of new primitive polynomials not only accommodates registers used for different desired key lengths, but also increases the randomization of each generated key. However, to preserve synchronization between the client 110 and server 150, the client seed generator 113 and the server seed generator 153 use the same primitive polynomials (and tap sequences). As with the primary key, the primitive polynomials are agreed upon a priori by the client 110 and server 150.

According to example embodiments of the present invention, key generator registers are clocked based on the state of other key generator registers. Referring to FIG. 2, LFSR 203 is clocked according to clocking module 211, whose output is dependent on the state of LFSR 201. Similarly, LFSR 205 is clocked according to clocking module 213, whose output is dependent on the state of LFSR 203. For example, if the output of clocking module 211 is a ‘1’, LFSR 203 clocks, and if the output of clocking module 211 is a ‘0’, LFSR 203 does not clock. LFSR 201 may be clocked according to an internal feedback clock, as shown in FIG. 2, or an external clock if desired.

The clocking modules 211-215 may be implemented as XOR gates, for example, although other logic functions may be implemented without deviating from the intended scope of the present invention. For example, if clocking module 213 is implemented as an XOR gate and bits corresponding to the tap sequence of LFSR 203 have an odd number of ‘1’s in a given state, clocking module 213 outputs a ‘1’ and LFSR 205 clocks.

Following a previous example, suppose LFSR 201 is set to 11 bits and initialized to ‘01001101001’, and the example primitive polynomial x¹⁰+x³+1 is used to determine the taps. Accordingly, bits corresponding to a ‘1’ (10th bit), a ‘0’ (3rd bit), and a ‘0’ (0th bit) are fed into clocking module 211. If clocking module 211 is implemented as an XOR gate, the XOR operation yields a ‘1’ result (odd number of ‘1’s), and clocking module 211 outputs a ‘1’ value signaling LFSR 203 to clock.

Thus, the pseudo-random initial state of the registers based on the shared primary key is used as a seed to generate other pseudo-random states. The permutations of the pseudo-random states are used to produce a cryptographic key stream seed of random bits without significant probability of repetition. With reference to FIG. 2, output module 220 uses the outputs of LFSR 201, LFSR 203, and clocking module 215 to produce the cryptographic key stream seed.

Similar to the clocking modules 211-215, the output module 220 may be implemented as an XOR gate, although other logic functions may be implemented without deviating from the scope of the present invention. As shown in FIG. 2, the cryptographic key stream seed may also be used as an internal feedback clock for the first LFSR 201.

Because the registers are initialized by the register controller 250 with essentially random information from the primary key, and are permuted in an essentially random manner according to tap sequences defined by primitive polynomials, generated cryptographic key stream seeds will include essentially random bits with nearly infinite periods. Furthermore, newly generated primitive polynomials and corresponding tap sequences produce different cryptographic key stream seeds from even identical initial states. The randomization of cryptographic key stream seeds generated by the seed generators 113/153 according to example embodiments of the present invention will therefore be robust even with significant lengths and/or repeated initial states.

The synchronization between the client 110 and server 150 of the cryptographic key stream seeds output by each seed generator 113/153 using the exchangers 115/155 to exchange of a series of polarized quantum packets, such as photons, will be described below.

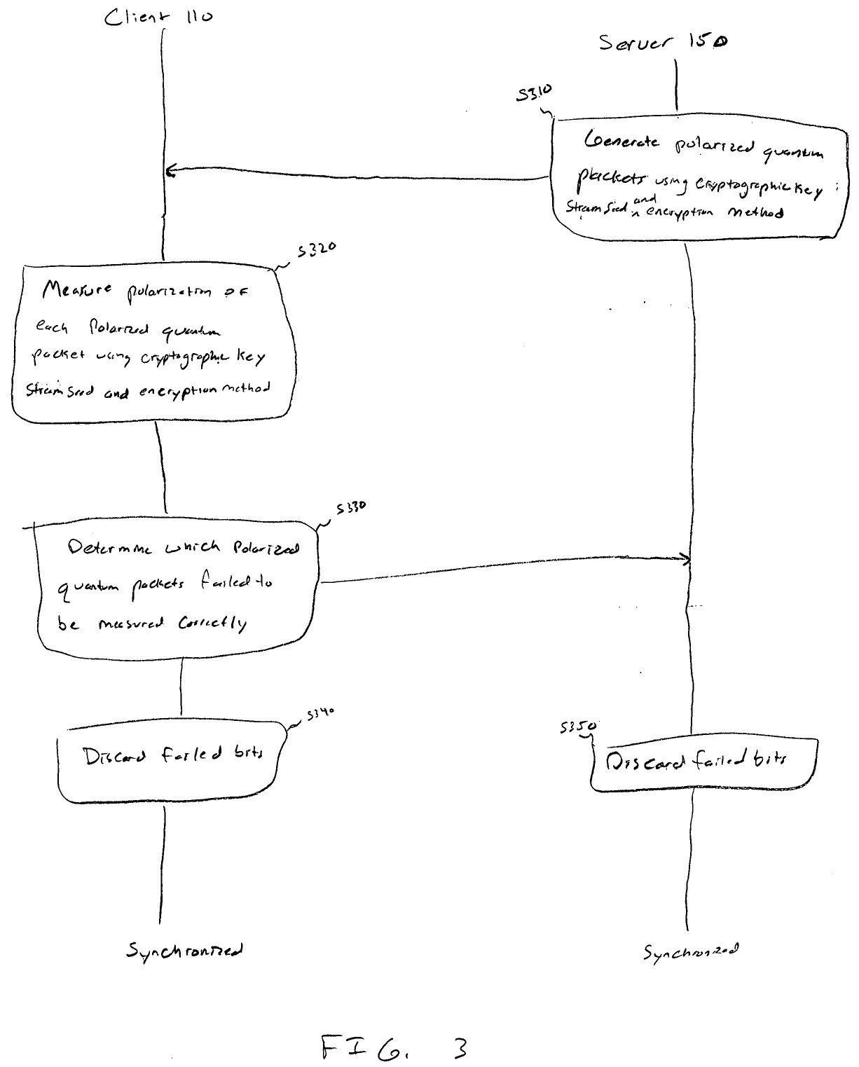

FIG. 3 is a client/server flow diagram illustrating the operation of the exchangers 115/155 of FIG. 1. The server exchanger 155 uses a light source, such as a light-emitting diode (LED) or a laser, to produce short pulses of light. The light pulses are filtered to achieve the desired polarization and intensity determined according to the server key synchronizer 155, and sent to the client 110 as a series of polarized quantum packets (S310), such as photons. The server key synchronizer 155 determines the canonical polarization of each quantum packet, including the appropriate basis, according to the cryptographic key stream seed generated by the seed generator 153 using a given encryption methodology known to both the client 110 and server 150 before the exchange.

For example, the polarization of each quantum packet may be determined according to the methodology in Table 1, as shown below.

TABLE 1

| Output | Canonical Polarization |
|---|---|
| 0 (first/non-alternate) | Horizontal |
| 1 (first/non-alternate) | Vertical |
| 0 (alternate) | Left Circular |
| 1 (alternate) | Right Circular |

According to the methodology of Table 1, if the server seed generator 153 generates a cryptographic key stream seed with the example bit pattern of ‘011 . . . ’, the quantum packets would be polarized as follows: horizontal polarization, vertical polarization, right circular polarization, etc.

The client key synchronizer 111 uses the cryptographic key stream seed generated by the client seed generator 113 according to the same methodology as the server key synchronizer 151 to measure the polarization of each quantum packet (S320). Because the client seed generator 113 ideally generates the same cryptographic key stream seed as the server seed generator 153, and the quantum exchange methodology is known to both the client 110 and server 150 a priori, the client key exchanger 155 anticipates which polarization basis to measure for each quantum packet received during the key exchange. Thus, inadvertent destruction of key exchange information due measurements made on the wrong polarization bases are reduced or minimized.

However, certain quantum packets may still fail to produce the measurements anticipated by the client exchanger 115. These failed measurements may result from a number of malicious and non-malicious sources. The client exchanger 115 sends the sequence numbers of any failed measurements to the server exchanger 155 to indicate which quantum packets were not received correctly (S330). The cryptographic key stream seed bits corresponding to the failed quantum packets will be discarded by both the client 110 and server 150 (S340/S350). A parity check may also be run as an additional safeguard.

The shared secret is thus synchronized between the client 110 and server 150.

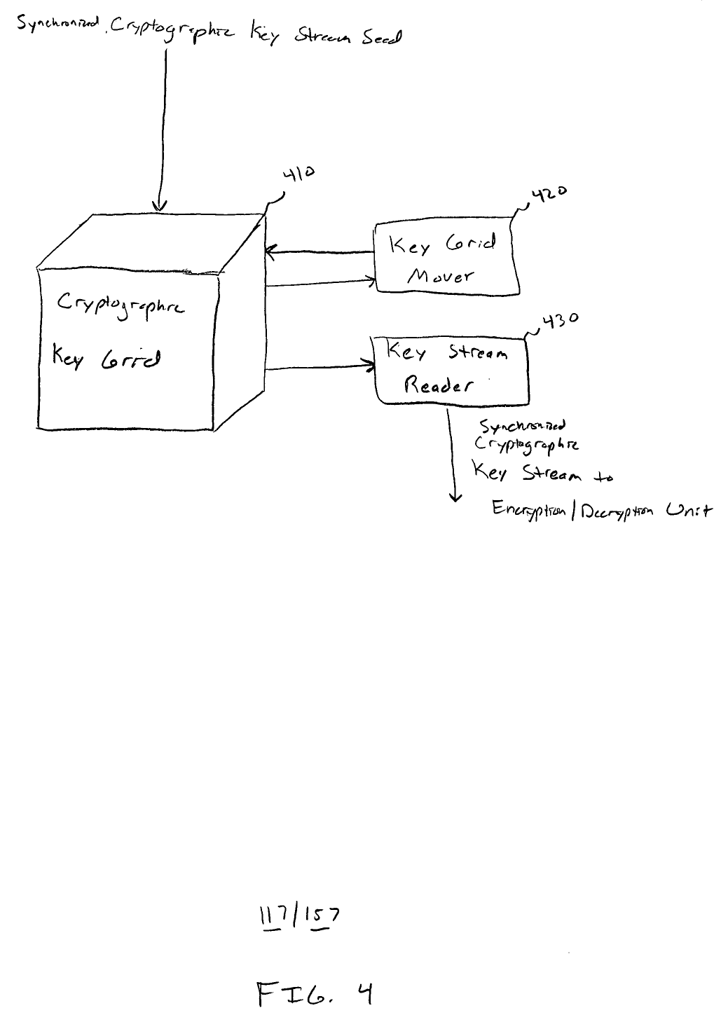

FIG. 4 illustrates a cryptographic key stream generator 117/157 according to an example embodiment of the present invention. The cryptographic key stream generator 117/157 includes a cryptographic key grid 410, a key grid mover 420, and/or a key stream reader 430. The key grid mover 420 and the key stream reader 430 are each connected to the cryptographic key grid 410. As shown, the key stream reader 430 receives the synchronized cryptographic key stream seed from the key synchronizer 111/151 and outputs a synchronized cryptographic key stream to the encryption/decryption unit 154/114. The operation of each component of the cryptographic key stream generator 117/157 will be described in more detail below with reference to additional figures.

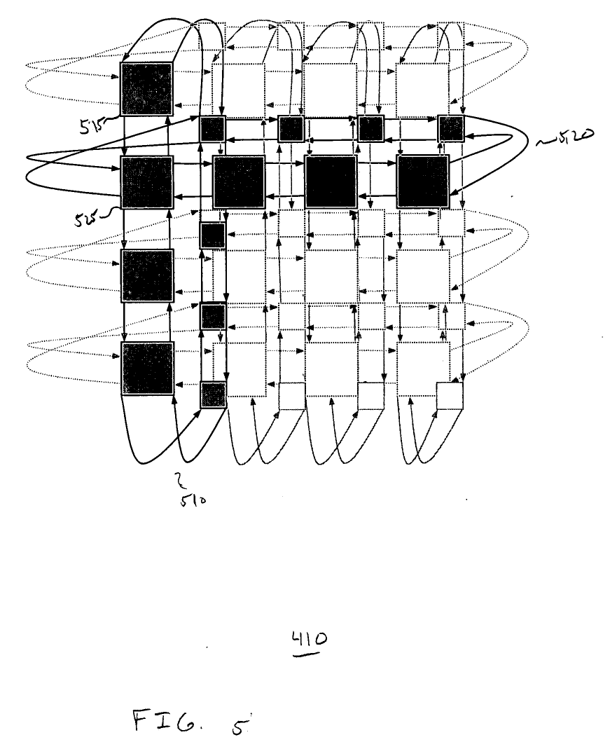

FIG. 5 illustrates an example layout of the cryptographic key grid 410 according to an example embodiment of the present invention. The cryptographic key grid 410 includes a series of circular doubly linked lists, each element of each list being connected to two adjacent horizontal neighbors and two adjacent vertical neighbors. The lists are circular in the sense that their ends are connected to each other, and doubly linked in the sense that there is a two-way communication between elements. Each element of each list holds a binary value.

As shown, FIG. 5 illustrates an example vertical circular doubly linked list 510 with head element 515, and an example horizontal circular doubly linked list 520 with head element 525. The functionality of each head element 515/525 will be described later. The cryptographic key stream seed synchronized between the client 110 and server 150 is used to populate (or initialize) the cryptographic key grid 410 of each cryptographic key stream generator 117/157.

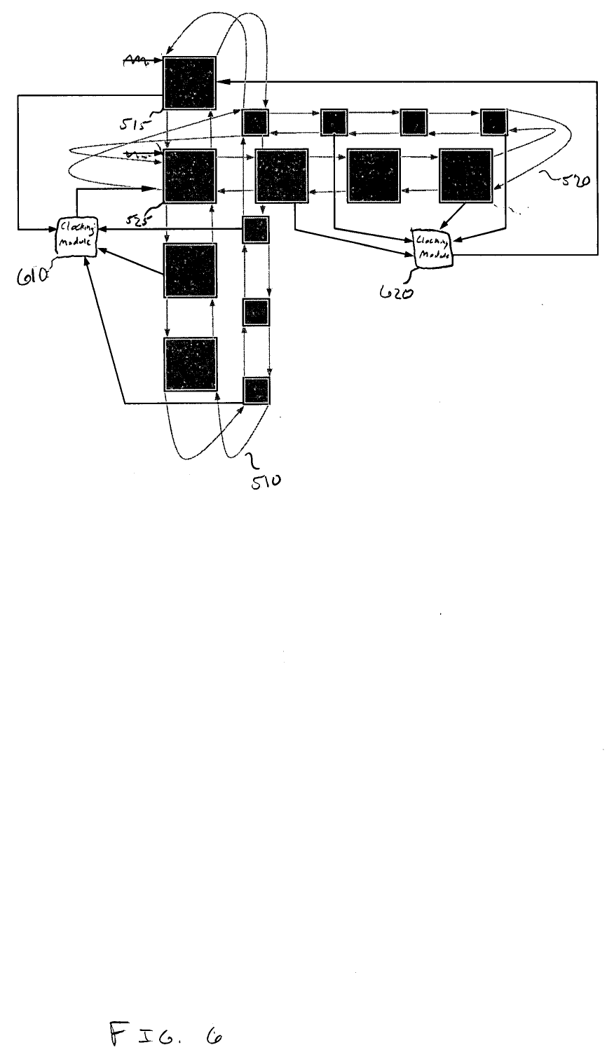

FIG. 6 illustrates example components of the key grid mover 420 for permuting the circular doubly linked lists 510/520 of FIG. 5 according to an example embodiment of the present invention. The key grid mover 420 includes clocking modules 610/620. As shown, vertical circular doubly linked list 510 is connected by certain tap bits to corresponding clocking module 610, and horizontal circular doubly linked list 520 is connected by certain tap bits to corresponding clocking module 620. The output of clocking module 610 is fed into head element 525 of the horizontal circular doubly linked list 520, and the output of clocking module 620 is fed into head element 515 of the vertical circular doubly linked list 510.

Key grid permutation will now be described with reference to FIG. 6. The operation of the key grid mover 420 illustrated in FIG. 6 is analogous to the operation of the seed generator 113/153 illustrated in FIG. 2. The key grid mover 420 permutes the circular doubly linked lists 510/520 similarly to the permutation of the LFSRs 201-205. For example, certain elements of each circular doubly linked list 510/520 are connected to a corresponding clocking module 610/620 according to a corresponding tap sequence defined by a primitive polynomial. Primitive polynomials and tap sequences having been described previously with reference to the seed generator 113/153 and FIG. 2, a more detailed description here will be omitted.

Each horizontal circular doubly linked list determines the clocking of a particular vertical circular doubly linked list via a corresponding clocking module of the key grid mover, and vice versa. As shown in FIG. 6, the horizontal circular doubly linked list 520 determines the clocking of the vertical circular doubly linked list 510 by the key grid mover 420 via the corresponding clocking module 620, and the vertical circular doubly linked list 510 determines the clocking of the horizontal circular doubly linked list 520 by the key grid mover 420 via the corresponding clocking module 610.

The clocking modules 610/620 of the key grid mover 410 send clocking signals (in the same manner as clocking modules 211-215 of FIG. 2) to the head elements 525/515, respectively. The head elements 515/525 signal their respective circular doubly linked lists to clock (i.e., shift their bit values to an adjacent element in the list). Thus, the clocking modules 610/620 of the key grid mover 420 are configured to permute each circular list based on the values of the bits of the elements defined by the tap sequence.

Because the permutation of a key grid may be computationally intensive, the number of primitive polynomials used in the permutations may be limited. For example, a set of four primitive polynomials may serve the horizontal circular doubly linked lists and another set of four primitive polynomials may serve the vertical circular doubly linked lists. The appropriate number of primitive polynomials used will depend on the available computational power of the system. The clocking modules 610/620 may be implemented, for example, by XOR gates, although other logical operations or combinations of operations may be used as well.

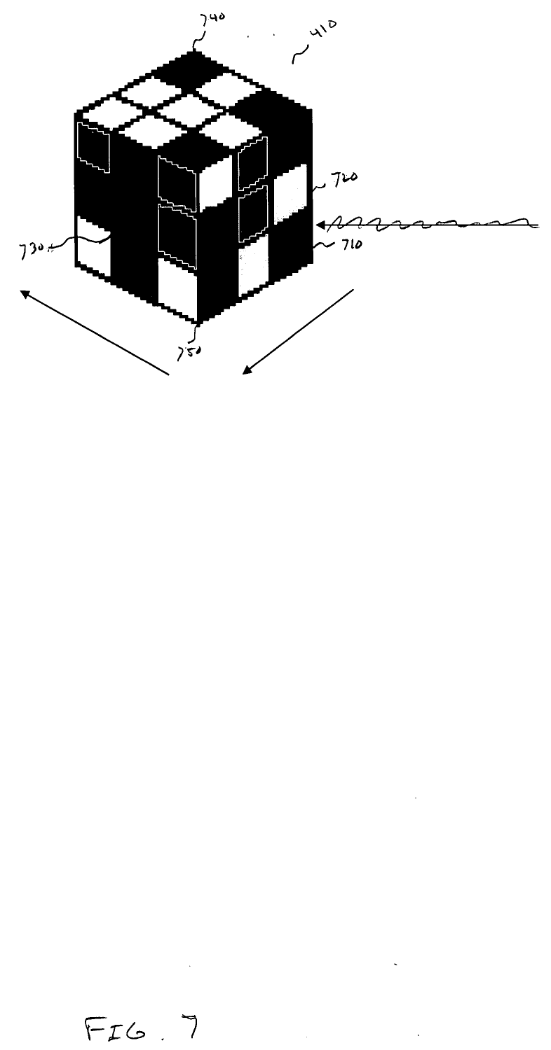

FIG. 7 is a 3-D block abstraction illustrating the operation of the key stream reader 430 for extracting a cryptographic key stream with a significantly low probability of repetition from the cryptographic key grid 410 according to an example embodiment of the present invention. The cryptographic key grid 410 is shown in FIG. 7 for illustration purposes as a 6-sided cube with nine elements arranged per side in three rows and the columns.

As shown, the key stream reader 430 begins extracting key stream bits at a designated start position 710 of the cryptographic key grid 410, and continues reading bits sequentially along the corresponding horizontal row list until it reaches an edge of the cryptographic key grid 410. The key stream reader 430 continues the read operation along the corresponding row of the adjacent face 730, etc., until it returns to the designated start position 710. The key stream reader 430 jumps to the next horizontal row 720 and continues around the cryptographic key grid 410 as previously described. Once all horizontal row lists have been read, the key stream reader 430 continues the read operation with the elements of cryptographic key grid 410 corresponding to the top face 740 and bottom face 750 in a clockwise manner.

The particular read order of elements described with reference to FIG. 7 is provided as an illustration, and not intended to limit the scope of the present invention. One of ordinary skill in the art will recognize that the particular read order of the elements of a key grid may be varied substantially, as long as the read order is known to both the client and server in order to preserve synchronization.

Once each element of the cryptographic key grid 410 has been read by the key stream reader 430, the circular doubly linked lists are permuted by the key grid mover 420 to rearrange the bits in a pseudo-random manner into a new state of the cryptographic key grid 410.

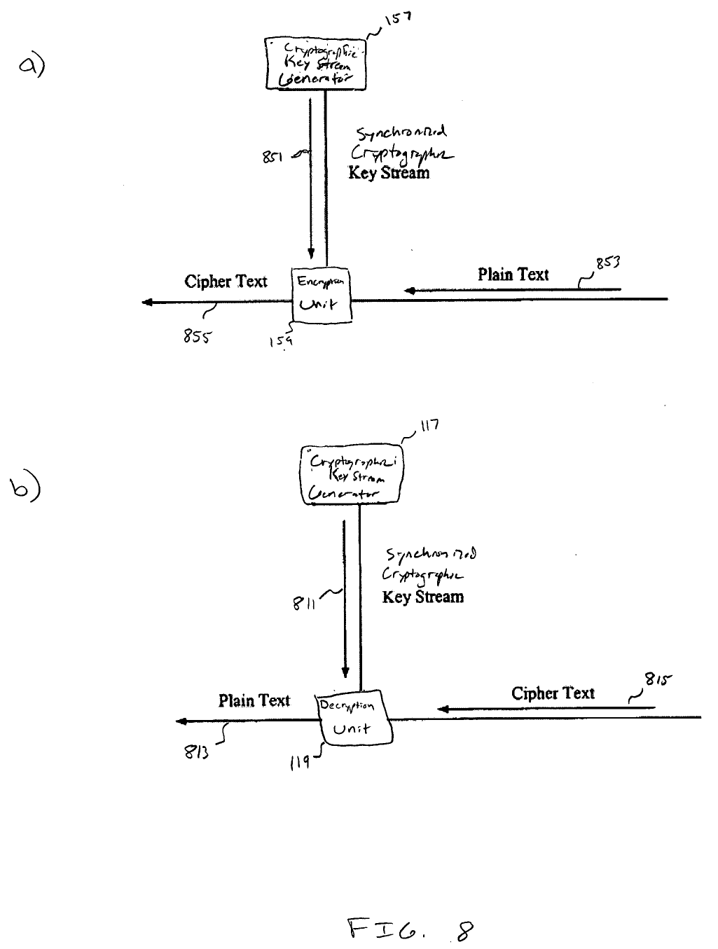

Referring to FIG. 1, the client cryptographic key stream generator 117 and the server cryptographic key stream generator 157 generate synchronized cryptographic key streams for use by the encryption/decryption units 119/159 of the crypto-system 100 of FIG. 1. FIGS. 8(a) and 8(b) illustrate encryption and decryption of data, using the synchronized cryptographic key streams of the server cryptographic key stream generator 157 and the client cryptographic key stream generator 117, respectively.

The server encryption unit 159, as shown in FIG. 8(a), generates cipher text 855 from plain text 853 using the synchronized cryptographic key stream 851 of the server cryptographic key stream generator 157. The cipher text 853 is transmitted to the client 110 as a cipher stream. The client decryption unit 119, as shown in FIG. 8(b), generates reconstructed plain text 813 from received cipher text 815 using the synchronized cryptographic key stream 811 of the client cryptographic key stream generator 117. The encryption/decryption units 119/159 may be implemented as XOR gates, for example, although other logic functions or well-known encryption/decryption algorithms may be implemented without deviating from the intended scope of the present invention.

The transmission and reception of the cipher stream may be accomplished by a variety of methods. For example, the cipher stream may be transmitted in quantum packets over a fiber optic channel. The basis for transmitting and receiving each binary bit using the cipher stream will depend on the specific implementation of the transmission, and all such implementations are intended to be included within the scope of the present invention.

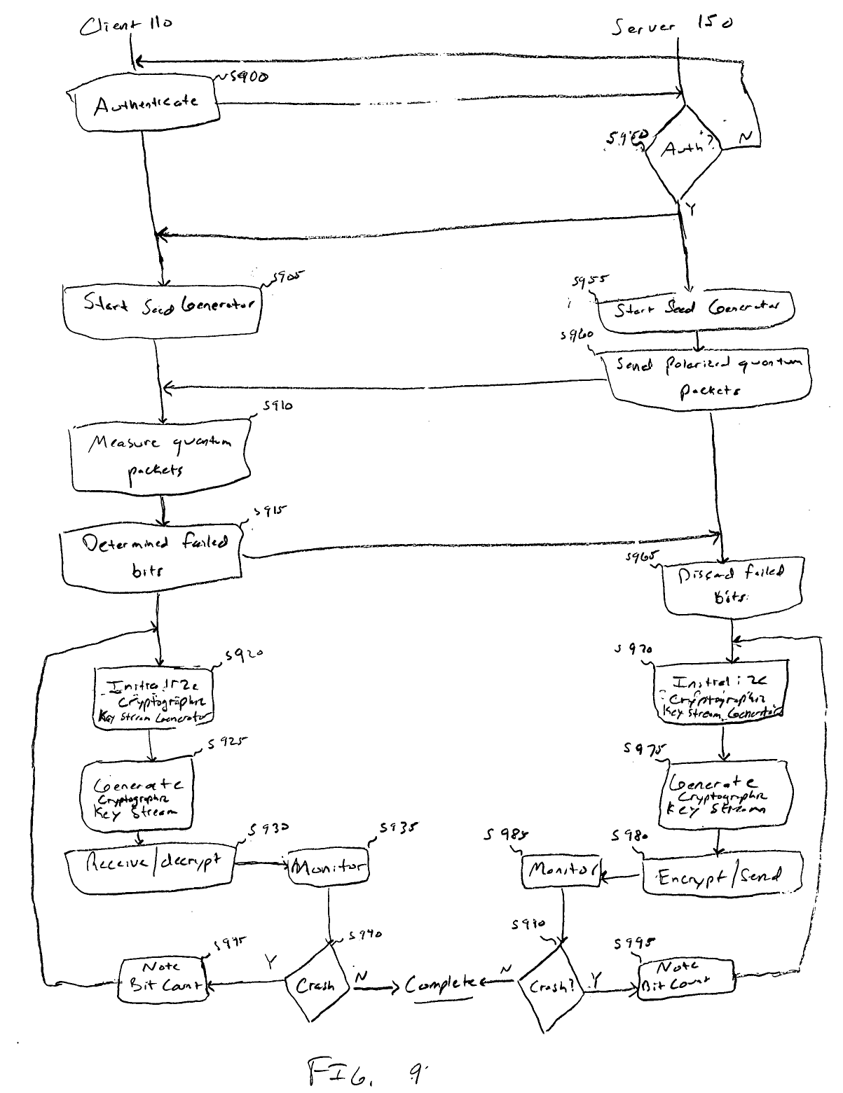

FIG. 9 is a client/server flow diagram illustrating a method of cryptographic data transfer between a server and a client according to an example embodiment of the present invention. The client 110 authenticates itself to the server 150 and seeks a transfer of data (S900). The server 150 determines if the client 110 is authenticated (S950). Once authentication is confirmed by the server 150, both the client 110 and the server 150 start corresponding key synchronizers 111/151 (S905/S955). Any well-known authentication scheme may be used.

The server 150 sends a series of polarized quantum packets, such as photons, to the client 110, the polarization values and bases of each polarized quantum packet being determined by the output of the server seed generator 153 according to an encryption methodology shared by the client 110 and server 150 (S960). The client 110 receives the series of polarized quantum packets and measures the polarization of each packet according to the polarization basis determined by the output of the client seed generator 111 and the shared encryption methodology (S910). The client 110 determines which bits are measured properly and which bits are not. The bits that fail to be measured properly by the client 110 are reported to the server 150 (S915) and discarded from the synchronized cryptographic key stream seed (S965).

The synchronized cryptographic key stream seed is used to initialize the cryptographic key stream generators 117/157 (S920/S970). The cryptographic key stream generators 117/157 are used to generate synchronized cryptographic key streams (S925/S975) and are periodically permuted to provide a synchronized cryptographic key stream with a significantly long period such that the probability of repetition is relatively low. The permutation may be performed by using selected bits according to a tap sequence of a primitive polynomial to pseudo-randomly shift parts of each cryptographic key stream generator 117/157. This produces another essentially random state of each cryptographic key stream generator 117/157 that may be used to generate distinct random bit sequences, while maintaining the synchronization of the client cryptographic key stream generator 117 and the server cryptographic key stream generator 157.

The server 150 encrypts data using the synchronized cryptographic key stream generated by the server cryptographic key stream generator 157 and sends it to the client (S980). The encrypted data is received by the client and decrypted using the synchronized cryptographic key stream generated by the client cryptographic key stream generator 117 (S930). Throughout the data transfer, the client 110 and the server 150 continuously monitor whether information is being transmitted and received properly (S985/S935). If it is determined that the client has crashed (S940/S990), the bit count is noted by both the client 110 and the server 150 (S945/S995), and the data transfer process is restarted at the appropriate point (S925/S975). Otherwise, the data transfer continues to completion (S930).

Example embodiments having thus been described, it will be obvious that the same may be varied in many ways. For example, the methods according to example embodiments may be implemented in hardware and/or software. The hardware/software implementations may include a combination of processor(s) and article(s) of manufacture. The article(s) of manufacture may further include storage media and executable computer program(s), for example, a computer program product stored on a computer readable medium.

The executable computer program(s) may include the instructions to perform the described operations or functions. The computer executable program(s) may also be provided as part of externally supplied propagated signal(s). Such variations are not to be regarded as a departure from the intended spirit and scope of example embodiments, and all such modifications as would be obvious to one skilled in the art are intended to be included within the scope of the following claims.

What is claimed is:

1. A crypto-system, comprising:
a key synchronizer configured to synchronize a cryptographic key stream with another communication entity using polarized photons; and
cryptographic circuitry configured to generate at least one of i) cipher text from plain text and ii) plain text from cipher text based on the synchronized key stream.

2. The crypto-system of claim 1, wherein the key synchronizer comprises:
a seed generator configured to generate a cryptographic key stream seed; and
an exchanger configured to synchronize the cryptographic key stream seed with the other communication entity by exchanging polarized photons, wherein
the cryptographic key stream is derived from the synchronized cryptographic key stream seed.

3. The crypto-system of claim 2, wherein the seed generator comprises:
a plurality of clocking modules configured to output clocking signals;
a plurality of linear feedback shift registers configured to permute based on the clocking signals; and
an output module configured to generate the cryptographic key stream seed from at least one of the clocking signals and output from at least one of the plurality of linear feedback shift registers, wherein
the plurality of clocking modules receive bits tapped from the plurality of linear feedback shift registers according to tap sequences derived from primitive polynomials.

4. The crypto-system of claim 3, wherein the clocking modules are XOR gates.

5. The crypto-system of claim 2, wherein the exchanger is further configured to determine the polarization value and basis of each polarized photon based on the cryptographic key stream seed, and to discard portions of the cryptographic key stream seed that fail synchronization with the other communication entity.

6. The crypto-system of claim 5, wherein the exchanger is configured to determine the polarization of each photon as a horizontally polarized photon for a first non-alternate ‘0’ of the cryptographic key stream seed, a vertically polarized photon for a first non-alternate ‘1’ of the cryptographic key stream seed, a left-circularly polarized photon for an alternate ‘0’ of the cryptographic key stream seed, and a right-circularly polarized photon for an alternate ‘1’ of the cryptographic key stream seed.

7. A random bit key stream generator, comprising:
a plurality of circular doubly linked lists forming a cryptographic key grid;
a key grid mover configured to permute the plurality of circular doubly linked lists; and
a key stream reader configured to extract a key stream from the cryptographic key grid.

8. The random bit key stream generator of claim 7, wherein the key grid mover permutes each of the plurality of circular doubly linked lists based on a state of a different one of the plurality of circular doubly linked lists.

9. The random bit key stream generator of claim 8, wherein the plurality of circular doubly linked lists includes horizontal circular doubly linked lists and vertical circular doubly linked lists, and each horizontal circular doubly linked list is permuted based on the state of a vertical circular doubly linked list, and each vertical circular doubly linked list is permuted based on the state of a horizontal circular doubly linked lists.

10. The random bit key stream generator of claim 8, wherein the key grid mover comprises:
a plurality of clocking modules, each clocking module configured to output a clocking signal to permute one of the plurality of circular doubly linked lists, the clocking signals being based on selected bits from another of the plurality circular doubly linked lists.

11. The random bit key stream generator of claim 10, wherein the plurality of clocking modules receive bits tapped from the plurality of circular doubly linked lists according to tap sequences derived from primitive polynomials.

12. The random bit key stream generator of claim 11, wherein each clocking module is an XOR gate.

13. A method of cryptographic data transfer, the method comprising:
synchronizing a generated cryptographic key stream seed with another communication entity to produce a synchronized cryptographic key stream seed by exchanging polarized photons;
generating a synchronized cryptographic key stream using the synchronized cryptographic key stream seed; and
at least one of i) encrypting information and ii) decrypting information using the synchronized cryptographic key stream.

14. The method of claim 13, wherein the synchronizing step comprises:
receiving at least one of the polarized photons from the other communication entity indicating portions of a received cryptographic key stream seed;
comparing the received portions of the received cryptographic key stream seed to corresponding portions of the generated cryptographic key stream seed;
reporting mismatched cryptographic key stream seed portions as unsynchronized cryptographic key stream seed portions to the other communication entity; and
generating a synchronized cryptographic key stream seed by discarding the unsynchronized cryptographic key stream seed portions.

15. The method of claim 14, wherein the synchronizing step further comprises:
measuring a polarization of each received polarized photon based on the generated cryptographic key stream seed.

16. The method of claim 15, wherein the measuring step measures the polarization of each received polarized photon in a horizontal polarization basis for a first non-alternate ‘0’ portion of the generated cryptographic key stream seed, in a vertical polarization basis for a first non-alternate ‘1’ portion of the generated cryptographic key stream seed, in a left-circular polarization basis for an alternate ‘0’ portion of the generated cryptographic key stream seed, and in a right-circular polarization basis for an alternate ‘1’ portion of the generated cryptographic key stream seed.

17. The method of claim 13, wherein the synchronizing step comprises:
sending the polarized photons to the other communication entity indicating portions of the generated cryptographic key stream seed;
receiving information reporting unsynchronized cryptographic key stream seed portions; and
generating a synchronized cryptographic key stream seed by discarding the unsynchronized cryptographic key stream seed portions from the generated cryptographic key stream seed.

18. The method of claim 17, wherein the synchronizing step further comprises:
modulating a polarization of each polarized photon based on the generated cryptographic key stream seed.

19. The method of claim 18, wherein the modulating step modulates the polarization of each polarized photon as a horizontal polarization for a first non-alternate ‘0’ portion of the generated cryptographic key stream seed, a vertical polarization for a first non-alternate ‘1’ portion of the generated cryptographic key stream seed, a left-circular polarization for an alternate ‘0’ portion of the generated cryptographic key stream seed, and a right-circular polarization for an alternate ‘1’ portion of the generated cryptographic key stream seed.

20. The method of claim 13, further comprising:
initializing a plurality of linear feedback shift registers based on a given prime number;
generating clocking signals based on bits tapped from the plurality of linear feedback shift registers according to tap sequences derived from primitive polynomials;
permuting at least one of the plurality of linear feedback shift registers based on the clocking signals; and
generating the generated cryptographic key stream seed from at least one clocking signal and output from at least one of the plurality of linear feedback shift registers.

21. The method of claim 13, wherein the generating the synchronized cryptographic key stream step comprises:
initializing a plurality of circular doubly linked lists forming a cryptographic key grid using the synchronized cryptographic key stream seed;
permuting the cryptographic key grid; and
extracting the cryptographic key stream from the cryptographic key grid.

22. The method of claim 21, wherein the permuting step permutes the cryptographic key grid by clocking the plurality of circular doubly linked lists according to tap sequences based on primitive polynomials.

23. The method claim 13, wherein i) encrypting information includes generating cipher text from plain text by XORing the plain text with the synchronized cryptographic key stream, and ii) decrypting information includes generating plain text from cipher text by XORing the cipher text with the synchronized cryptographic key stream.

24. A method of generating a random bit key stream, comprising:
initializing a plurality of circular doubly linked lists forming a cryptographic key grid using a seed;
permuting the cryptographic key grid; and
extracting a cryptographic key stream from the cryptographic key grid.

25. The method of claim 24, wherein the permuting step permutes each of the plurality of circular doubly linked lists based on a state of a different one of the plurality of circular doubly linked lists.

26. The method of claim 25, wherein the permuting step comprises:
clocking at least one of the plurality of circular doubly linked lists based on bits tapped from another of the plurality circular doubly linked lists according to a corresponding tap sequence derived from a corresponding primitive polynomial.
